(19) United States
(12) Patent Application Publication
(10) Pub. No.: US 2004/0047733 A1
(43) Pub. Date: Mar. 11, 2004

(54) High torque accumulator wind machine

(76) Inventor: Leonardo M. Gasendo, Camarillo, CA (US)

Correspondence Address: LEONARDO M. GASENDO, 11238 Leisure Village Drive, Camarillo, CA, 93012, US

(21) Appl. No.: 10/238,304

(22) Filed: Sep. 10, 2002

(51) Int. Cl. F03D 3/02

(52) U.S. Cl. 416/120; 416/99; 416/169 R

(57) ABSTRACT

A high torque accumulator wind machine comprising a rotor means that comprise a plurality of blade assemblies that have ratchet bearings, an electric generator and a tower means that expose a plurality of blade assemblies to the wind to capture large amounts of wind enrgy in low wind velocity areas as well as in high wind velocity areas wherein the torque elements produced by the blade assemblies are delivered by the torque transporter means to the high torque accumulator shaft that combines the delivered torque elements into a single big force for rotating said electric generator thereby enabling said high torque accumulator wind machine to produce more electricity than conventional means at lower expenses.

### REFERENCES CITED

U.S. Patent Documents

| U.S. Document No. | Publication Date | Patentee |
|---|---|---|
| 4,353,702 | Oct. 12, 1982 | Nagy |
| 1,300,499 | Apr. 15, 1919 | Slagel |
| 4,127,356 | Nov. 28, 1978 | Murphy |
| 4,303,835 | Dec. 1, 1981 | Bair |
| 4,432,695 | Feb. 21, 1984 | Voitsekhovsky |
| 1,007,317 | Nov. 16, 1926 | Spencer |
| 3,986,786 | Oct. 19, 1976 | Sellman |
| 4,522,600 | Jun. 11, 1985 | Jost |
| 4,118,144 | Oct. 3, 1978 | Kellley |
| 1,178,729 | Apr. 11, 1916 | Kemble |
| 1,502,433 | Jul. 22, 1924 | Johanson |
| 4,527,950 | Jul. 9, 1985 | Biscomb |
| 4,031,405 | Jun. 21, 1977 | Asperger |
| 4,360,315 | Nov. 23, 1982 | Olson |

### BACKGROUND OF THE PRESENT INVENTION

A prior art windmill comprises a rotor blade assembly, an electric generator connected to the rotor blade assembly and a high tower that supports the rotor blade assembly and electric generator at high elevation. The skinny rotor blades of prior art windmill have narrow wind contact areas so much so that a high percentage of the available wind energy are allowed to escape and wasted through the wide gaps of the blade swept area.

In the windmill farm near Palm Springs, Calif. more than 4,000 prior art windmills are catching insufficient amount of wind energy to produce electricity at low efficiency for the following reasons (a) a high percentage of the available wind energy is wasted through the wide gaps of the blade swept area (b) one inadequate skinny blade assembly is used in rotating the heavy electric generator (c) more than 4,000 electric generators are giving resistance to the work of the skinny rotor blades (d) more than 4,000 high towers are blocking the wind flow to the rotor blades.

### OBJECT OF THE PRESENT INVENTION

It is the object of the present invention to provide a high torque accumulator wind machine that is using a plurality of blade assemblies for rotating one electric generator to produce electricity.

It is the object of the present invention to provide a high tower for exposing a plurality of blade assemblies to the wind at high elevation.

It is the object of the present invention to provide a plurality of blade assemblies that have ratchet bearings and to install said blade assemblies in a manner wherein the wind energy that escapes capture by the front blade assembly is captured by the rear blade assembly.

It is the object of the present invention to provide a torque transporter means that will transport the torque elements from the blade assemblies to the high torque accumulator shaft.

It is the object of the present invention to provide a high torque accumulator means to combine the numerous torque elements from the blade assemblies and non-wind related sources into a single big force to rotate the electric generator to produce electricity.

### BRIEF DESCRIPTION OF THE DRAWINGS

FIG. 1 is the isometric view of the High Torque Accumulator Wind Machine of the present invention.

FIG. 2 is the side view of the present invention.

FIG. 3 is the side view of the present invention that is showing the cross sectional view of the blade assemblies that have ratchet bearings and the cross sectional view of the pulleys that have ratchet bearings.

FIG. 4 is the isometric view of the horizontal platform that includes a plurality of vertical supports, a vertical swivel on which the horizontal platform is rigidly secured to.

FIG. 5 is the isometric view of the vertical tower that includes a vertical support 16b and bearings 16a and 16c.

FIG. 6 is the isometric view of the alternate embodiment of the present invention.

### DETAILED DESCRIPTION OF THE DRAWINGS

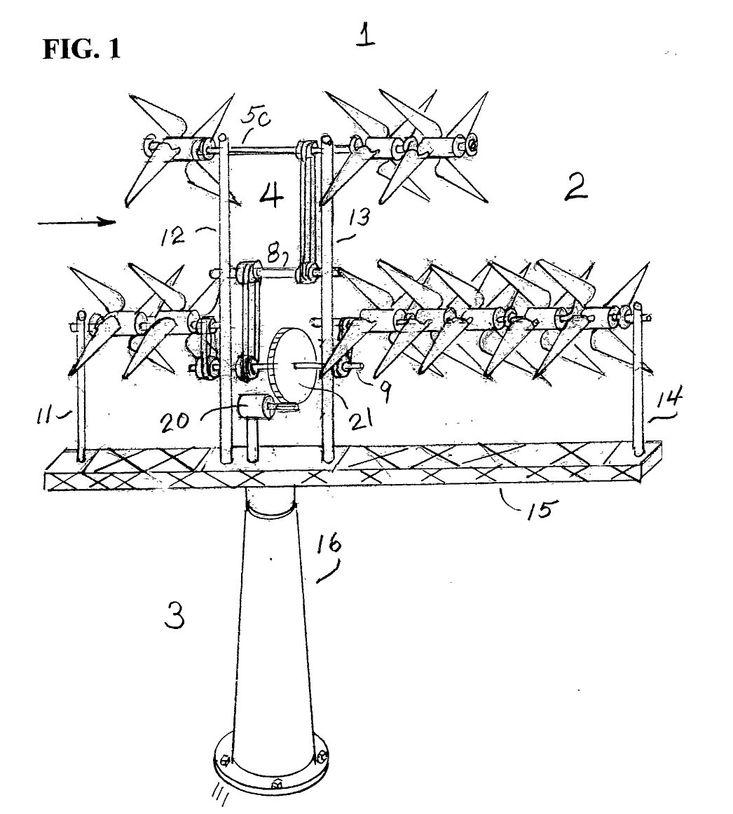

In FIG. 1, the high torque accumulator wind machine is designated as numeral 1 that includes a rotor assembly 2, a tower support means 3, a torque transporter means 4, a high torque accumulator shaft 9 that combines the numerous contributed torque elements into a single big force for rotating the electric generator 20.

Rotor assembly 2 comprises a plurality of blade assemblies that have ratchet bearings, collar and blades, platform, plurality of horizontal shafts.

Tower support means 3 comprise a tower 16, horizontal platform 15, and plurality of vertical supports 11, 12, 13, 14.

Torque transporter means comprise a plurality of blade assemblies, shafts, belts, pulleys.

High torque accumulator means comprise a high torque accumulator shaft, speed multiplier gear and electric generator.

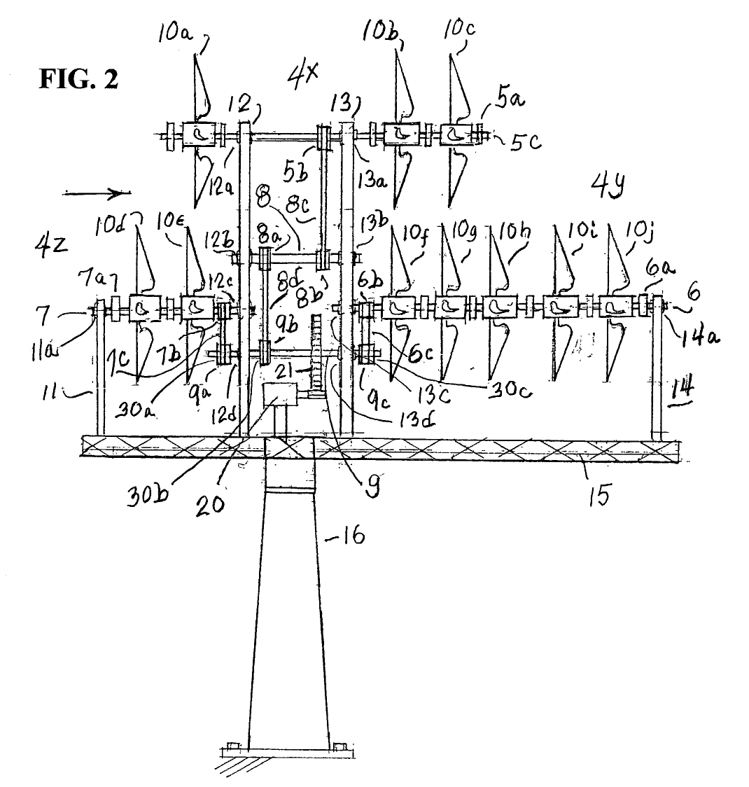

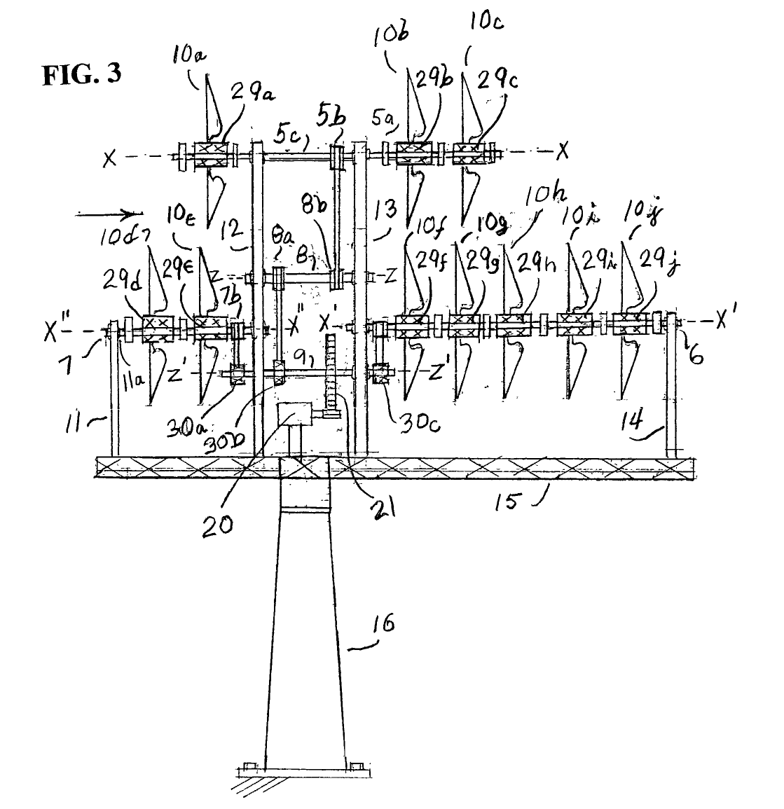

In FIG. 2, shaft 8 is horizontally and rotatably carried by bearing 13b at vertical support 13 and bearing 12b at vertical support 12. Pulleys 8a and 8b are rigidly secured to shaft 8. Bearings 13b and 12b enhance the rotation of shaft 8. In FIG. 3, shaft 8 is axial and rotatable about z-z axis.

In FIG. 2, shaft 9 is horizontally and rotatably carried on bearing 13d at vertical support 13 and bearing 12d at vertical support 12. Speed multiplier gear 21 is rigidly secured to shaft 9 for rotating electric generator 20. Bearings 12d and 13d enhance the rotation of shaft 9. In FIG. 3 shaft 9 is axial and rotatable about z′-z′ axis. Pulleys 9a, 9b, 9c with ratchet bearings 30a, 30b, 30c respectively are axial and rotatable about the shaft 9 axis.

In FIG. 2, shaft 5c is horizontally and rotatably carried on bearing 13a at the top end of vertical support 13 and bearing 12a at the top end of vertical support 12. Bearings 13a and 12a enhance the rotation of shaft 5c. Thrust bearing stoppers 5a and pulley 5b are rigidly secured to shaft 5c. In FIG. 3, shaft 5c is axial and rotatable about x-x axis. Blade assemblies 10a, 10b, and 10c with ratchet bearings 29a, 29b and 29c respectively are axial and rotatable about the shaft 5c axis. Tower 16 is rigidly secured to the ground.

As the wind load rotates either one of the blade assemblies 10a, 10b, 10c their corresponding ratchet bearings 29a, 29b, 29c automatically engage to drive mode and cooperatively rotate shaft 5c. Without wind load on either one of the blade assemblies 10a, 10b, 10c their corresponding ratchet bearings 29a, 29b, 29c automatically disengage to neutral mode without giving resistance to the rotation of shaft 5c. During operation not all blade assemblies have wind loads simultaneously. Only blade assemblies on drive mode are rotating shaft 5c cooperatively while the blade assemblies on neutral mode are free-wheeling without giving resistance to the rotation of shaft 5c. Vertical supports 11, 12, 13, 14 are rigidly secured to the top of platform 15.

In FIG. 2, the torque elements from shaft 5c are transported by torque transporter means that is designated as numeral 4x to the high torque accumulator shaft 9 as follows: from shaft 5c to pulley 5b, belt 8c, pulley 8b, shaft 8, pulley 8a, belt 8d, pulley 9b with ratchet bearing 30b, shaft 9, speed multiplier gear 21, to electric generator 20. Without wind load on blade assemblies 10a, 10b, 10c the ratchet bearing 30b of pulley 9b automatically disengages to neutral mode without giving resistance to the rotation of shaft 9. Electric generator 20 is rigidly secured to the top of platform 15.

In FIG. 2, shaft 6 is horizontally and rotatably carried by bearing 14a at the top end of vertical support 14 and bearing 13c of vertical support 13. Thrust bearing stoppers 6a and drive pulley 6b are rigidly secured to shaft 6. In FIG. 3, shaft 6 is axial and rotatable about x′-x′ axis. Blade assemblies 10f, 10g, 10h, 10i, 10j with ratchet bearings 29f, 29g, 29h, 29i, 29j respectively are axial and rotatable about the shaft 6 axis. As the wind load rotates any one of the blade assemblies 10f, 10g, 10h, 10i, 10j their corresponding ratchet bearings 29f, 29g, 29h, 29i, 29j automatically engage to drive mode and cooperatively rotate shaft 6. Without wind load on either one of the blade assemblies 10f, 10g, 10h, 10i, 10j their corresponding ratchet bearings 29f, 29g, 29h, 29i, 29j automatically disengage to neutral mode without giving resistance to the rotation of shaft 6. During operation not all blade assemblies have wind loads simultaneously. Only blade assemblies with wind load are cooperatively rotating shaft 6 while the blade assemblies without wind load are free wheeling without giving resistance to the rotation of shaft 6.

In FIG. 2, the torque elements from shaft 6 are delivered by torque transporter means that is designated as numeral 4y to the high torque main shaft 9 as follows: from shaft 6 to drive pulley 6b, belt 6c, pulley 9c with ratchet bearings 30c, shaft 9, speed multiplier gear 21, to electric generator 20. Without wind load on blade assemblies 10f, 10g, 10h, 10i, 10j ratchet bearings 30c disengage to neutral mode without giving resistance to the rotation of shaft 9.

In FIG. 2, shaft 7 is horizontally and rotatably carried on bearing 12c at vertical support 12 and bearing 11a at vertical support 11. Thrust bearing stoppers 7a and pulley 7b are rigidly secured to shaft 7. In FIG. 3 shaft 7 is axial and rotatable about x″-x″ axis. Blade assemblies 10d, 10e with ratchet bearing 29d, 29e respectively are axial and rotatable about shaft 7 axis.

As the wind load rotates either one of the blade assemblies 10d and 10e, their corresponding ratchet bearings 29d, 29e automatically engage to drive mode and cooperatively rotate shaft 7. Without wind load on either one of the blade assemblies 10d and 10e their corresponding ratchet bearings 29d and 29e automatically disengage to neutral mode without giving resistance to the rotation of shaft 7. During operation not all the blade assemblies have wind loads simultaneously. Only blade assemblies on drive mode are rotating shaft 7 cooperatively while the blade assemblies on neutral mode are free wheeling without giving resistance to the rotation of shaft 7.

In FIG. 2 the torque elements from shaft 7 are delivered by torque transporter means that is designated as numeral 4z to the high torque main shaft 9 as follows: from shaft 7 to pulley 7b, belt 7c, pulley 9a with ratchet bearing 30a, shaft 9, speed multiplier gear 21 and to electric generator 20. Without wind load on blade assemblies 10d, 10e the ratchet bearing 30a of pulley 9a automatically disengages to neutral mode without giving resistance to the rotation of shaft 9.

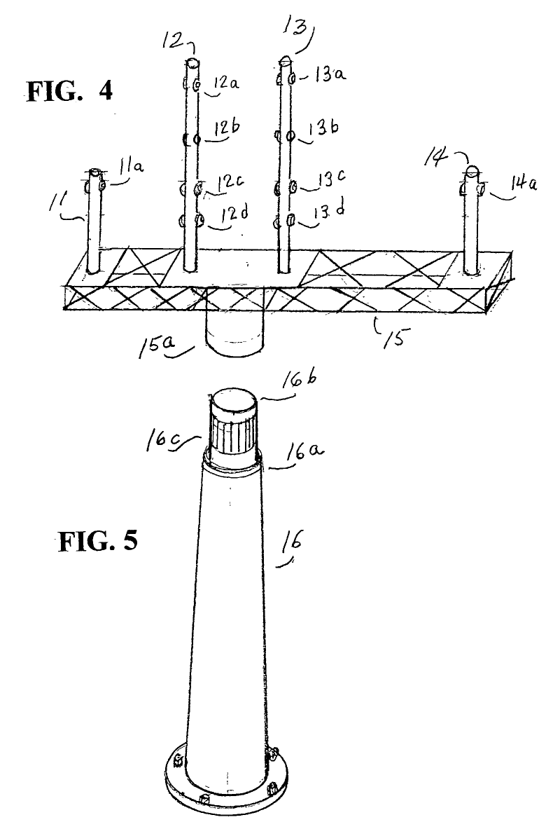

Referring to FIGS. 4 and 5, platform 15 is horizontally and rigidly secured to the vertical top end of swivel 15a. Swivel 15a is mounted rotatably, concentrically, exteriorly to the vertical support 16b of tower 16. Bearing 16a and 16c enhance the rotation of swivel 15a about the vertical support 16b.

In FIG. 2, inasmuch as more blade assemblies are rotatably mounted on vertical supports 13 and 14 this permits the wind forces which are acting on blade assemblies 10b, 10c, 10f, 10g, 10h, 10i, 10j to also act to pivot platform 15 and orient the blade assemblies directly into the wind.

As can best be seen in FIG. 2 blade assemblies 10a, 10b, 10c, 10d, 10e, 10f, 10g, 10h, 10i, 10j are working cooperatively in harvesting more wind energy to supply more torque elements for rotating the electric generator to produce more electricity than conventional means. There is a low percentage of wind energy escapees because the wind energy that escapes capture by the front blade assembly is captured by the rear blade assemblies. In FIG. 2, the wind energy that escapes capture by blade assembly 10a is captured by the rear blade assembles 10b and 10c. And the wind energy that escapes capture by the blade assemblies 10a and 10b is capture by the blade assembly 10c. In addition the rear blade assemblies are simultaneously catching the front wind energy escapees and the fresh wind energy that is supplied by the side winds thus increasing the capture of wind energy by the present invention.

In FIGS. 1 and 4, by increasing the length and width of platform 15 and increasing the numbers and height of vertical supports 11, 12, 13, 14 tower 16 will expose more than 100 said blade assemblies to the wind at high elevation for rotating one electric generator 20 wherein, said expanded high torque wind machine 1 is capable of generating more electricity in low wind velocity areas because the low torque produced by each individual blade assembly is combined by the high torque main shaft 9 into a single big force to rotate electric generator 20 to produce more electricity than conventional means at lower cost.

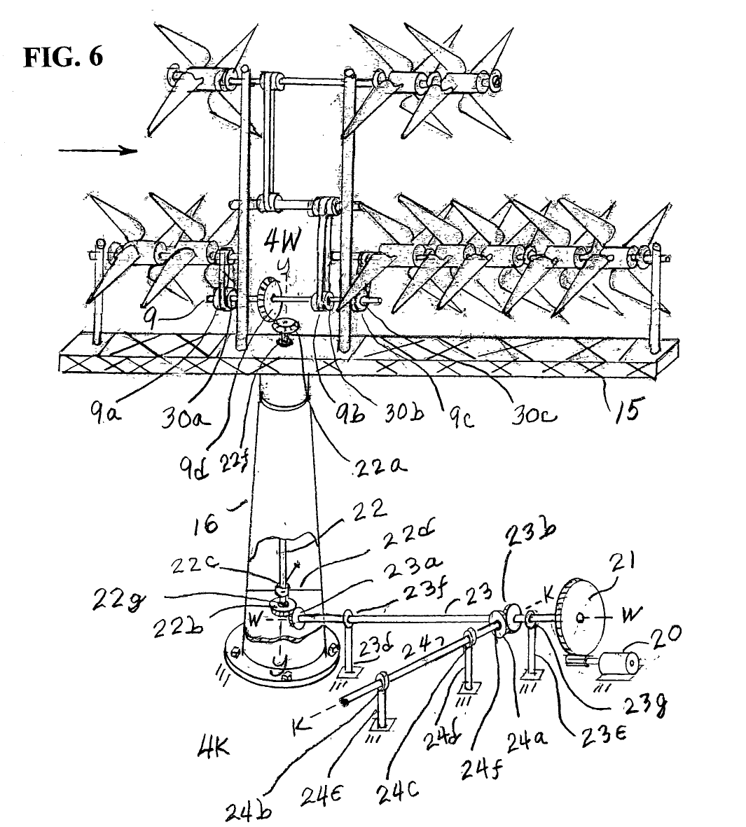

FIG. 6 is the alternate embodiment of the present invention wherein the speed multiplier 21 and electric generator 20 are located at ground level in order to accumulate and combine the torque elements of wind power, water power, solar power, geothermal power and other power sources into a big single force for rotating the electric generator 20 to produce more electricity than conventional means. Bevel gear 9d is rigidly secured to shaft 9. Bevel gear 9d rotatably engages top bevel gear 22a of vertical shaft 22. Bevel gear 22a is rigidly secured to shaft 22. Bevel gear 22b with ratchet bearing 22g is rotatably secured to shaft 22. Shaft 22 is axial and rotatable about y-y axis. Bearings 22c and 22f enhance the rotation of vertical shaft 22. Bearing 22f on top of platform 15 rotatably support vertical shaft 22. Horizontal struts 22d are rigidly secured to tower 16 and radially hold bearings 22c which rotatably support vertical shaft 22. Bevel gear 22b rotatably engages bevel gear 23a of horizontal shaft 23.

Bevel gears 23a, 23b and speed multiplier 21 are rigidly secured to shaft 23, Bearings 23f of vertical support 23d and bearings 23g of vertical support 23e enhance the rotation of horizontal shaft 23. Shaft 23 is axial and rotatable about w-w axis.

Bevel gear 24a with ratchet bearing 24f is rotatably secured to horizontal shaft 24. Bearing 24c of vertical support 24d and bearing 24b of vertical support 24e enhance the rotation of horizontal shaft 24. Shaft 24 is axial and rotatable about k-k axis. The torque elements of water power, wave power, solar power, geothermal power and other power sources are supplied to shaft 24 and shaft 23 through bevel gear 24a which rotatably engages bevel gear 23b thereby rotating shaft 23.

As the torque element load rotates shaft 24, ratchet bearing 24f of bevel gear 24a automatically engages to drive mode and rotates bevel gear 23b and horizontal shaft 23. Without torque element load on shaft 24, ratchet bearing 24f automatically disengages to neutral mode without giving resistance to the rotation of shaft 23. The torque elements from shaft 9 and shaft 24 are accumulated and combined into a big single force in shaft 23 for rotating speed multiplier gear 21 and electric generator 20 to produce more electricity than conventional means at lower expenses. Tower 16, vertical supports 23d, 23e, 24d, 24e, electric generator 20 are rigidly secured to the ground.

In FIG. 6, the torque elements from shaft 24 are delivered by the torque transporter means that is designated as numeral 4k to the high torque accumulator shaft 23 as follows: from shaft 24 to bevel gear 24a with ratchet bearing 24f, bevel gear 23b, shaft 23, speed multiplier gear 21 and electric generator 20. Without torque element load on shaft 24 the ratchet bearing 24f automatically disengages to neutral mode without giving resistance to the rotation of shaft 23.

Also in FIG. 6, the torque element from shaft 9 are delivered by the torque transporter means that is designated as numeral 4w to the torque accumulator shaft 23 as follows: from shaft 9 to bevel gear 9d, bevel gear 22a, vertical shaft 22, bevel gear 22b with ratchet bearing 22g, bevel gear 23a, shaft 23, speed multiplier gear 21 and to electric generator 20. Without torque element load on shaft 9 the ratchet bearing 22g of bevel gear 22b automatically disengages to neutral more without giving resistance to the rotation of shaft 23.

As can best be seen in FIG. 6, the torque transporter means 4x, 4y, 4z, 4w, 4k have a wide area of applications for accumulating and combining the torque elements of wind power, water power, wave power, solar power, geothermal power and other power sources into a big single force for rotating the speed multiplier gear 21 and electric generator 20 to produce more electricity than conventional means wherein a plurality of horizontal shafts are connected in offline segments by belts, shafts and gears thereby enabling the present invention to produce large amounts of electricity at lower expenses in low wind velocity areas as well as in high wind velocity areas.

The features and combinations illustrated and described herein represent a more advance concepts in wind power machine designs and they are significant elements of the present invention. These include all alternatives and equivalents within the broadest scope of each claim as understood in the light of the prior art.

What is claimed is:

1. A high torque accumulator wind machine comprising in combination:
a rotor assembly means comprising a plurality of rotor blade assemblies that have ratchet bearings, collar, and blades, horizontal platform, plurality of horizontal shafts,
Tower support means comprising of plurality of blade assemblies, horizontal shafts, belts, pulleys,
Torque transporter means comprising of plurality of blade assemblies that have ratchet bearings, horizontal shafts, belts, pulleys,

2. A high torque accumulator wind machine as set forth in claim 1 wherein said plurality of blade assemblies that have ratchet bearings are used for rotating one electric generator to produce electricity. And wherein one tower is used to expose a plurality of blade assemblies to the wind at high elevation wherein the wind energy that escape capture by the front blade assembly is captured by the rear blade assembly. Additionally the rear blade assemblies are simultaneously catching the front wind energy escapees and the fresh side wind energy that is supplied by the side winds thus increasing the capture of the wind energy by the present invention.

3. A high torque accumulator wind machine as set forth in claim 1 that captures more wind energy in low wind velocity areas as well as in high wind velocity areas to produce more electricity than conventional means at lower expenses.

4. A high torque accumulator wind machine as set forth in claim 1 additionally comprising means of accumulation of torque elements from external, non-wind related sources such as water power, wave power, solar power, geothermal power.

5. Torque accumulator means that deliver numerous torque elements produced by the blade assemblies to the high torque accumulator shaft that combines said numerous torque elements into a single big force for rotating the electric generator to produce more electricity than conventional means wherein the plurality of horizontal shafts are connected in off-line segments by belts, pulleys and gears thereby enabling said blade assemblies to cooperatively capture more wind energy that is transported in the form of torque elements to rotate the electric generator.
